(19) United States
(12) Patent Application Publication
(10) Pub. No.: US 2026/0049846 A1
(43) Pub. Date: Feb. 19, 2026

(54) METAL DETECTOR

(71) Applicant: ANRITSU CORPORATION, Kanagawa (JP)

(72) Inventors: Tomohiko YAMAGUCHI, Kanagawa (JP); Yuki HAYAKAWA, Kanagawa (JP)

(21) Appl. No.: 19/289,646

(22) Filed: Aug. 4, 2025

(30) Foreign Application Priority Data
Aug. 15, 2024 (JP) 2024-135606

(51) Int. Cl. G01D 5/20

(52) U.S. Cl. CPC G01D 5/20

(57) ABSTRACT

Provided is a metal detector that reduces capacitive coupling between a transmitting coil and a receiving coil and is easy to handle. A metal detector that determines whether or not metal is contained in an inspection object, the metal detector including: a housing; a transmitting coil and a receiving coil disposed inside the housing; a holding material configured to hold the transmitting coil and the receiving coil in the housing; and a shield member disposed between the transmitting coil and the receiving coil. An electrical resistivity of the shield member is higher than an electrical resistivity of the housing.

### TECHNICAL FIELD

The present invention relates to a metal detector.

### BACKGROUND ART

The metal detector is a device that determines whether or not metal is contained in an inspection object by detecting a change in inspection magnetic field caused by metal contained in the inspection object.

In general, the metal detector detects metal contained in an inspection object passing through the vicinity using a magnetic field from a transmitting coil forming a magnetic field output unit to a receiving coil forming a magnetic field receiving unit. However, in the metal detection, there is an effect of an electric field (so-called capacitive coupling) other than a magnetic field, which may be an inhibiting factor of sensitivity improvement or stability improvement of the metal detector. One important matter for performing appropriate inspection is to reduce capacitive coupling between the receiving coil or the transmitting coil and the inspection object.

Patent Document 1 discloses that an electrostatic shield sheet is mounted on a portion where an inspection object and a transmitting coil or a receiving coil face each other to shield the effect of static electricity. Patent Document 2 discloses an electrostatic shield that reduces capacitive coupling between a transmitting coil or a receiving coil and an inspection object.

### RELATED ART DOCUMENT

### Patent Document

[Patent Document 1] Japanese Patent No. 2614180
[Patent Document 2] JP-A-2005-017118

### DISCLOSURE OF THE INVENTION

### Problem That the Invention is to Solve

The metal detector detects metal contained in an inspection object using two receiving coils based on a balanced voltage (differential voltage) that is a difference between induced voltages generated from the two receiving coils along with passage of the inspection object. The difference between the induced voltages in the two receiving coils is ideally 0 in a non-detection state of the inspection object, and is adjusted to be 0 at the time of manufacturing and assembly of the metal detector.

However, the state of the metal detector changes depending on factors such as a change in ambient conditions. At this time, the difference between the induced voltages in the two receiving coils gradually varies in the non-detection state such that the detection of metal cannot be accurately performed.

The variation in balanced voltage is affected particularly by a change in ambient conditions. The change in ambient conditions includes a change in magnetic coupling generated between members such as a transmitting coil, a receiving coil, and a housing. In the related art, a mechanical adjustment method of inserting a metal sheet, a metal rod, or the like into the metal detector such that the balanced voltage is in the ideal state is adopted. However, with this method, it is difficult to deal with the variation in balanced voltage depending on the change in ambient conditions, and handling of the metal detector including adjustment work is difficult.

The present invention relates to a metal detector that reduces capacitive coupling between a transmitting coil and a receiving coil and is easy to handle.

### Means for Solving the Problem

According to the present invention, there is provided a metal detector that determines whether or not metal is contained in an inspection object, the metal detector including:
a housing;
a transmitting coil and a receiving coil disposed inside the housing;
a holding material configured to hold the transmitting coil and the receiving coil in the housing; and
a shield member disposed between the transmitting coil and the receiving coil in the housing,
in which an electrical resistivity of the shield member is higher than an electrical resistivity of the housing.

In addition, according to the present invention, there is provided a metal detector that determines whether or not metal is contained in an inspection object, the metal detector including:
a housing;
a transmitting coil and a receiving coil disposed inside the housing;
a holding material configured to hold the transmitting coil and the receiving coil in the housing; and
a shield member disposed between the transmitting coil and the receiving coil in the housing,
in which an electrical resistivity, a disposition, a shape, and an area of the shield member are configured such that an attenuation of a magnetic field in the presence of the shield member is a value that is 50% or less of a magnetic field generated by the transmitting coil in an inspection region in the absence of the shield member.

### Advantage of the Invention

According to the present invention, capacitive coupling between the transmitting coil and the receiving coil is reduced, and the metal detector is easy to handle.

### BRIEF DESCRIPTION OF THE DRAWINGS

FIG. 1 is a block diagram illustrating a metal detector.

FIG. 2 is a perspective view illustrating a metal detector according to a first embodiment, in which particularly a configuration of a detection head is illustrated.

FIG. 3 is a side view illustrating the metal detector according to the first embodiment, in which particularly a side surface and an inner portion of the detection head are illustrated.

FIG. 4 is a side view illustrating a metal detector according to a second embodiment, in which particularly a side surface and an inner portion of a detection head are illustrated.

FIG. 5 is a side view illustrating a metal detector according to a third embodiment, in which particularly a side surface and an inner portion of a detection head are illustrated.

FIG. 6 is a perspective view illustrating a metal detector according to a fourth embodiment, in which particularly a configuration of a detection head is illustrated.

FIG. 7 is a side view illustrating the metal detector according to the fourth embodiment, in which particularly the side surface and the inner portion of the detection head are illustrated.
FIGS. 8A to 8C are diagrams illustrating another example of a shield member.

FIGS. 9A and 9B are diagrams illustrating an example where shield members are doubly disposed.

FIGS. 10A and 10B are diagrams illustrating another example where shield members are doubly disposed.

FIG. 11 is a diagram illustrating an example where a transmitting coil is surrounded with a cylindrical shield member.

FIG. 12 is a diagram illustrating an example where a shield member extending in an axial direction is disposed in a gap between a transmitting coil and a receiving coil in a coaxial detection head.

FIG. 13 is a diagram illustrating another example where the shield member extending in the axial direction is disposed in a gap between the transmitting coil and the receiving coil in the coaxial detection head.

FIG. 14 is a diagram illustrating a disposition example of another shield member in a one-sided detection head.

FIGS. 15A and 15B are diagrams illustrating a disposition example of another shield member in the one-sided detection head.

FIG. 16 is a diagram illustrating a grounding example of a palisaded shield member.

FIG. 17 is a diagram illustrating another grounding example of the palisaded shield member.

FIG. 18 is a diagram illustrating a relation between a distance from a grounding point and a shielding effect.

FIG. 19 is a diagram illustrating an example where the shield member is grounded at multiple points.

FIG. 20 is a diagram illustrating an example where a divided shield member is grounded.

### BEST MODE FOR CARRYING OUT THE INVENTION

### Overall Configuration of Metal Detector

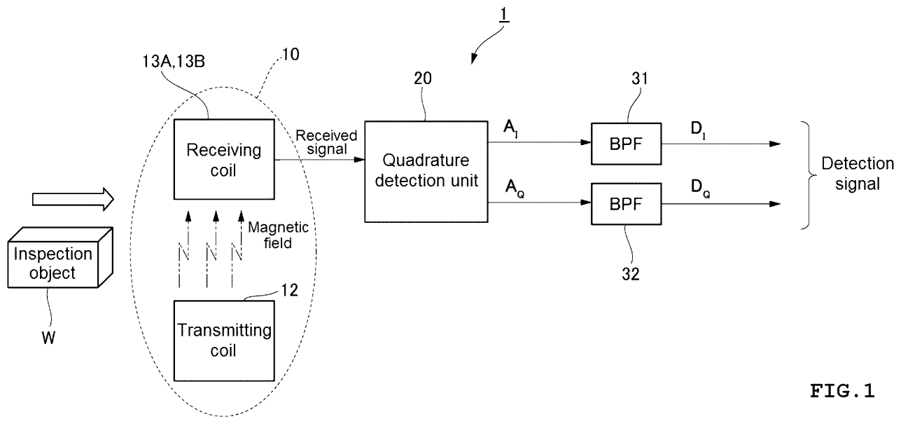

FIG. 1 is a block diagram illustrating a general metal detector that is known in the related art. A metal detector 1 is a device that determines whether or not metal is contained in an inspection object W. The metal detector 1 includes a detection head 10, a quadrature detection unit 20, band-pass filters (BPF) 31 and 32, and transport means (not illustrated) for transporting an inspection object W.

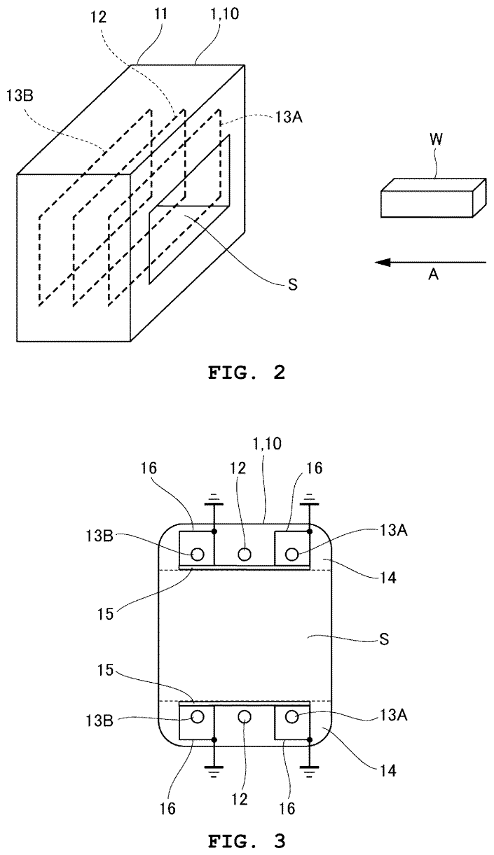

The detection head 10 includes a transmitting coil 12 (refer to FIG. 2) forming a magnetic field output unit and receiving coils 13A and 13B (refer to FIG. 2) forming a magnetic field receiving unit. The detection head 10 detects metal contained in the inspection object W passing through the vicinity of the transmitting coil 12 and the receiving coils 13A and 13B using a magnetic field from the transmitting coil 12 to the receiving coils 13A and 13B. The details of the detection head 10 will be described with reference to FIG. 2 and the like.

The magnetic field is modulated by passing through the inspection object W. The quadrature detection unit 20 performs demodulation (quadrature detection) to extract a modulation component from the modulated received signal. The band-pass filters 31 and 32 filter detected signals A_{I} and A_{Q} from the quadrature detection unit 20 to restrict a frequency band other than a desired frequency band, and extract detection signals D_{I} and D_{Q} required for detection. A detection circuit (not illustrated) analyzes the detection signals D_{I} and D_{Q} to determine whether or not metal is contained in the inspection object W passing through the vicinity.

### First Embodiment

FIG. 2 is a perspective view illustrating a metal detector 1 according to a first embodiment, in which particularly a configuration of a detection head 10 is illustrated. FIG. 3 is a side view illustrating the metal detector 1 according to the first embodiment, in which particularly a side surface and an inner portion of the detection head 10 are illustrated. The detection head 10 of the metal detector 1 includes a housing 11, the transmitting coil 12, the receiving coils 13A and 13B, a holding material 14, a conductive sheet 15, and a shield member 16.

The housing 11 is formed of, for example, a material of an electrostatic shield such as metal (for example, an aluminum alloy or stainless steel). The housing 11 has a hollow quadrangular shape, in which an inspection space S (inspection region) is formed and a transport conveyor (not illustrated) that transports the inspection object W is disposed to penetrate the inspection space S.

The transmitting coil 12 and the receiving coils 13A and 13B are disposed in the housing 11. The transmitting coil 12 and the receiving coils 13A and 13B are disposed such that the two receiving coils 13A and 13B are positioned before and after the transmitting coil 12 along a passage direction (passage direction A illustrated in FIG. 2) of the inspection object W. The transmitting coil 12 generates a line of magnetic force parallel to the passage direction A of the inspection object W. That is, the detection head 10 of the metal detector 1 according to the present embodiment is a coaxial detection head where the transmitting coil 12 and the receiving coils 13A and 13B are disposed to form the same axis along the passage direction of the inspection object W.

In the detection head 10, in the inspection space S continuous to the inside of the transmitting coil 12 and the receiving coils 13A and 13B, induced voltages V1 and V2 having opposite phases are generated in the two receiving coils 13A and 13B, respectively, perpendicular to a magnetic flux generated by an alternating magnetic field of the transmitting coil 12 at the center. The receiving coils 13A and 13B are disposed at the same distance from the transmitting coil 12, and in a non-detection state where the inspection object W is positioned far from the inspection space S, the magnitudes of the induced voltages V1 and V2 are the same such that a difference therebetween is 0.

For example, when the inspection object W where the metal is contained advances in the passage direction A and moves in the receiving coil 13A in the front, a magnetic flux density in the receiving coil 13A increases, and conversely a magnetic flux density in the receiving coil 13B on the depth side decreases. Therefore, the induced voltage V1 of the receiving coil 13A is more than the induced voltage V2 of the receiving coil 13B. Next, when the advanced inspection object W moves up to the inside of the receiving coil 13B, the magnetic flux density in the receiving coil 13B is more than that in the receiving coil 13A. Therefore, the induced voltage V2 is more than the induced voltage V1. This way, whether or not metal is contained in the inspection object W passing through the inside of the inspection space S can be determined based on a change (fluctuation in magnetic field) in the difference between the induced voltages V1 and V2 output from the detection head 10.

The holding material 14 is a member for holding the transmitting coil 12 and the receiving coils 13A and 13B in the housing 11, and is formed of, for example, a member having insulating properties such as an epoxy resin. An internal space of the housing 11 is filled with the holding material 14 according to the present embodiment. However, the internal space does not need to be completely filled with the holding material 14 as long as the holding material functions to hold the transmitting coil 12 and the receiving coils 13A and 13B in the housing 11.

The conductive sheet 15 is disposed between the transmitting coil 12 and the receiving coils 13A and 13B and an inner surface of the housing 11 on the inspection space S side. The transmitting coil 12 and the receiving coils 13A and 13B are wound around the inner surface of the housing 11 on the inspection space S side through the conductive sheet 15. The conductive sheet 15 has conductivity, capacitive coupling between the transmitting coil 12 and the receiving coils 13A and 13B and the inspection object W passing through the inspection space S is reduced, and the effect of the inspection object W or the effect of noise from the outside is reduced. As a result, a decrease in metal detection accuracy is suppressed.

The shield member 16 is a uniform sheet-like member disposed between the transmitting coil 12 and the receiving coils 13A and 13B in the housing 11. The shield member 16 functions as an electrostatic shield that reduces the degree of capacitive coupling between the transmitting coil 12 and the receiving coils 13A and 13B. An electrical resistivity, a disposition, a shape, and an area of the shield member 16 are configured such that an attenuation of a magnetic field by the shield member 16 is a value that is 50% or less of a magnetic field generated by the transmitting coil 12 in the inspection space S in the absence of the shield member 16.

As described above, the metal detector 1 detects metal contained in the inspection object W using the two receiving coils 13A and 13B based on a balanced voltage (differential voltage) that is a difference between the induced voltages V1 and V2 having opposite phases generated along with passage of the inspection object W. In the non-detection state of the inspection object W, the difference between the induced voltages in the two receiving coils 13A and 13B is ideally 0.

However, the state of the metal detector changes depending on factors such as a change in ambient conditions. At this time, the difference between the induced voltages in the two receiving coils gradually varies in the non-detection state such that the detection of metal cannot be accurately performed.

The variation in balanced voltage is affected particularly by a change in ambient conditions. The change in ambient conditions includes a change in magnetic coupling generated between members such as the transmitting coil 12, the receiving coils 13A and 13B, and the housing 11. In the related art, a mechanical adjustment method of inserting a metal sheet, a metal rod, or the like into the metal detector such that the balanced voltage is in the ideal state is adopted. However, with this method, it is difficult to deal with the variation in balanced voltage depending on the change in ambient conditions, and handling of the metal detector 1 including adjustment work is difficult.

Accordingly, in the present embodiment, the shield member 16 functions to reduce the degree of capacitive coupling between the transmitting coil 12 and the receiving coils 13A and 13B. The shield member 16 reduces the degree itself of capacitive coupling between the transmitting coil 12 and the receiving coils 13A and 13B. Therefore, a variation in balanced voltage caused by a change in the degree of capacitive coupling can be reduced, and an accurate metal detection function can be ensured while facilitating the balance adjustment work.

In order to reduce the degree of capacitive coupling between the transmitting coil 12 and the receiving coils 13A and 13B, the shield member 16 has conductivity to some extent, and the electrical resistivity is reduced to be low. However, that the electrical resistivity of the shield member 16 is excessively low (the conductivity is excessively high) causes large attenuation to a magnetic field generated by the transmitting coil 12 in the inspection space. Therefore, the shield member 16 needs to have a certain degree of electrical resistivity.

Accordingly, in the present embodiment, the electrical resistivity of the shield member 16 is set to be higher than the electrical resistivity of the housing 11 formed of a material having high conductivity (low electrical resistivity) such as metal. As a result, while reducing an excessive attenuation of a magnetic field generated from the transmitting coil 12 in the inspection space to ensure the function of the metal detector, the shield member 16 reduces capacitive coupling between the transmitting coil 12 and the receiving coils 13A and 13B, and the metal detector 1 is easy to handle.

From the viewpoint of the electrostatic shield action, it is important to set the electrical resistivity of the shield member 16 based on a square resistance (ohms/square, hereinafter, Ω/□) that is a resistance per area. The electrical resistivity of the shield member 16 is set to be in a range of, for example, 10⁻² Ω/□ to 10³ Ω/□. The square resistance is also called a surface resistance, a sheet resistance, or the like. As a result, while reducing an excessive attenuation of a magnetic field generated from the transmitting coil 12 in the inspection space, capacitive coupling between the transmitting coil and the receiving coil can be reduced. A numerical range represented using “to” refers to a range including numerical values described before and after “to” as a lower limit value and an upper limit value.

The metal used for the housing 11 or the like has a square resistance of about 10⁻⁴ Ω/□ to 10⁻³ Ω/□, and the electrical resistivity of the shield member 16 is higher than the electrical resistivity of the housing 11. In addition, the holding material 14 is a member having insulating properties, and the electrical resistivity of the shield member 16 is lower than the electrical resistivity of the holding material 14.

A material forming the shield member 16 is not particularly limited. For example, the shield member 16 can be formed by applying or bonding a conductive material to a predetermined base material. The base material may be, for example, a resin base material such as bakelite. The conductive material may include, for example, carbon having conductivity. By adopting carbon, the shield member 16 can be easily formed. The material of the shield member 16 may be the same as or different from the material of the conductive sheet 15.

In the present embodiment, a coaxial detection head 10 where the transmitting coil 12 and the receiving coils 13A and 13B are disposed to form the same axis along the passage direction A of the inspection object W is configured. Since the detection head 10 is a general coaxial type, the detection head 10 can be easily assembled.

In addition, in the present embodiment, the shield member 16 is, for example, an annular body having a hollow quadrangular cross-section, and surrounds the periphery (each side) of the receiving coils 13A and 13B using a combination of sheet-like members. Accordingly, the shield member 16 covers the entirety of the receiving coils 13A and 13B. As a result, capacitive coupling between the transmitting coil 12 and the receiving coils 13A and 13B can be easily and efficiently reduced. Note that the shield member 16 does not need to completely cover the receiving coils 13A and 13B, and a slit or the like may be provided in the shield member 16. The size of the slit or the like is desirably a length that is ¼ or less of a wavelength of an electromagnetic wave to be reduced.

### Second Embodiment

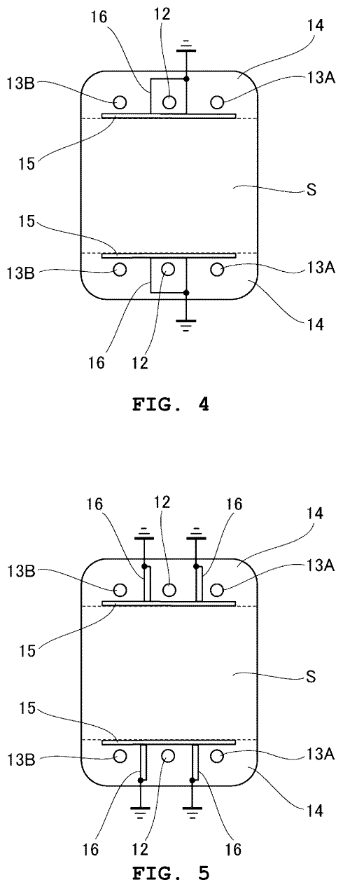

FIG. 4 is a side view illustrating a metal detector 1 according to a second embodiment, in which particularly a side surface and an inner portion of the detection head 10 are illustrated. A basic configuration of the detection head 10 is common to that of the first embodiment. In the present embodiment, the shield member 16 surrounds the periphery (each side) of the transmitting coil 12. Accordingly, the shield member 16 covers the entirety of the transmitting coil 12. As a result, capacitive coupling between the transmitting coil 12 and the receiving coils 13A and 13B can be easily and efficiently reduced. A structure of the shield member 16 is the same as that of the first embodiment. In addition, by combining the first and second embodiments, both of the transmitting coil 12 and the receiving coils 13A and 13B may be surrounded with the shield member 16.

### Third Embodiment

FIG. 5 is a side view illustrating a metal detector 1 according to a third embodiment, in which particularly a side surface and an inner portion of the detection head 10 are illustrated. A basic configuration of the detection head 10 is common to that of the first and second embodiments. In the present embodiment, the shield member 16 is disposed between the transmitting coil 12 and the receiving coils 13A and 13B in a direction of the same axis of the detection head 10 (the left-right direction in FIG. 5 and the passage direction A of the inspection object W (refer to FIG. 2)). The shield member 16 is a sheet member extending along each of the sides of the transmitting coil 12 (or the receiving coils 13A and 13B), and although the shield member 16 does not surround the transmitting coil 12 or the receiving coils 13A and 13B, capacitive coupling between the transmitting coil 12 and the receiving coils 13A and 13B can be easily and efficiently reduced.

### Fourth Embodiment

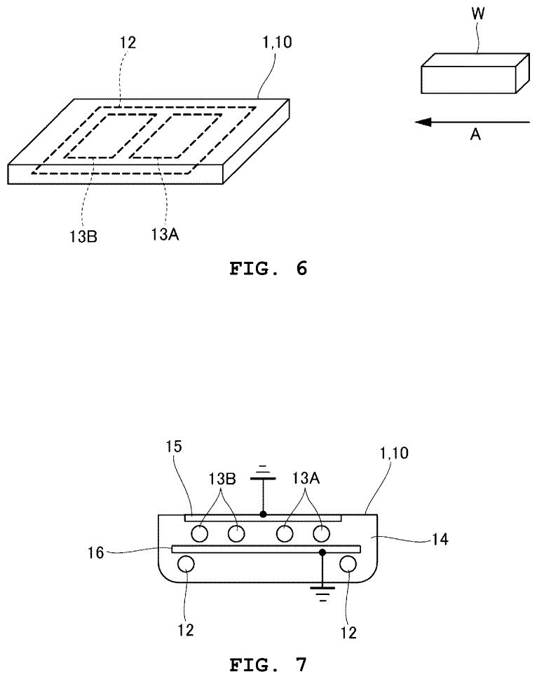

FIG. 6 is a perspective view illustrating a metal detector 1 according to a fourth embodiment, in which particularly a configuration of a detection head 10 is illustrated. FIG. 7 is a side view illustrating the metal detector 1 according to the fourth embodiment, in which particularly the side surface and the inner portion of the detection head 10 are illustrated. In the present embodiment, an upper surface side of the detection head 10 is the inspection region (inspection space), and the inspection object W advances on the upper surface of the detection head 10 in the passage direction A. The one-sided detection head 10 where the transmitting coil 12 and the receiving coils 13A and 13B are disposed to form the same axis along a direction orthogonal to the passage direction A of the inspection object W is configured. In the one-sided detection head 10, whether or not metal is contained in the inspection object W can be determined through the same principle as that of the coaxial detection head 10 according to the first to third embodiments.

The shield member 16 is disposed between the transmitting coil 12 and the receiving coils 13A and 13B in the direction of the same axis (the passage direction A of the inspection object W). Although the shield member 16 is, for example, a sheet-like member and does not surround the transmitting coil 12 or the receiving coils 13A and 13B, capacitive coupling between the transmitting coil 12 and the receiving coils 13A and 13B can be easily and efficiently reduced.

### Other Examples of Shield Member

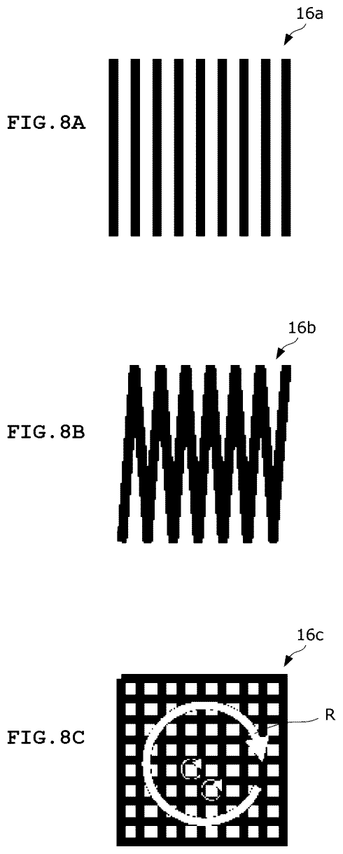

Each of the above-described embodiments shows the example where, by using a uniform sheet-like member having a predetermined electrical resistivity (for example, 10⁻² Ω/□ to 10³ Ω/□), the shield member 16 functions as an electrostatic shield without largely interfering with a magnetic field. However, the shield member is not limited to the above-described example. For example, when it is desirable to further reduce interference with a magnetic field, as the shield member disposed between the transmitting coil and the receiving coil, a shield member 16a or 16b having a palisaded structure illustrated in FIGS. 8A and 8B (a comb-shape in FIG. 8A, and a zigzag shape in FIG. 8B) or a shield member 16c having a network (lattice-like) structure illustrated in FIG. 8C can be used.

In addition, when a uniform sheet material having a low electrical resistivity of, for example, less than 10⁻² Ω/□ is used as the shield member, a large eddy current is generated under the action of a magnetic field such that the magnetic field is attenuated. In this case, the shield member has a shape for restricting a path where an eddy current is generated as illustrated in FIGS. 8A, 8B, and 8C, the shield member can function as an electrostatic shield without largely interfering with a magnetic field. An electrical resistivity, a disposition, a shape, and an area of each of the shield members 16a, 16b, and 16c illustrated in FIGS. 8A to 8C are configured such that an attenuation of a magnetic field by each of the shield members 16a, 16b, and 16c is a value that is 50% or less of a magnetic field generated by the transmitting coil 12 in the inspection region in the absence of each of the shield members 16a, 16b, and 16c. The shield members 16a, 16b, and 16c having the above-described shapes can be configured, for example, using a metal mesh or a printed board. Here, the shield member 16c (FIG. 8C) has a network pattern and can form a large loop R. Therefore, it is considered that, although the shield member 16c is more likely to attenuate a magnetic field than the shield members 16a and 16b, a path where an eddy current is generated is further restricted as compared to the uniform sheet-like shield member 16. Accordingly, it is considered that the attenuation effect of a magnetic field by the shield member 16c is lower than that by the shield member 16 having a uniform sheet-like shape.

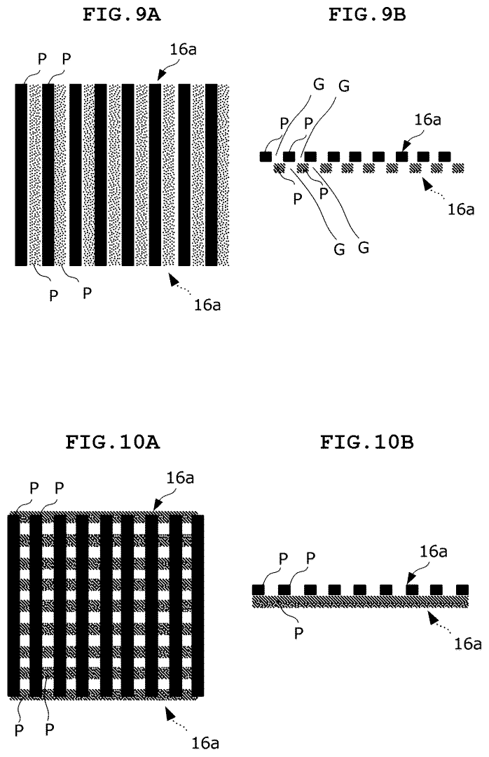

By disposing layer of the shield members 16a, 16b, and 16c, the shielding effect may be further improved. For example, when the shield members 16a are disposed in two layers, a gap through which an electric field is leaked can be eliminated as much as possible as illustrated in FIGS. 9A to 10B. As a result, the shielding effect can be further improved. In each of the examples illustrated in FIGS. 9A to 10B, two shield members 16a are disposed to overlap each other in a thickness direction. In FIGS. 9A to 10B, FIGS. 9A and 10A are top views, and FIGS. 9B and 10B are side views when seen from below in FIGS. 9A and 10A. In the example of FIGS. 9A and 9B, the two shield members 16a are disposed such that a plurality of strap portions P forming one shield member 16a are positioned between gaps G between a plurality of strap portions P of the other shield member 16a, respectively, while being maintained parallel to the plurality of strap portions P forming the other shield member 16a. In the example of FIGS. 10A and 10B, the two shield members 16a are disposed such that the plurality of strap portions P forming the one shield member 16a are orthogonal to the plurality of strap portions P forming the other shield member 16a. When the shield members are disposed in two layers, an electrical resistivity, a disposition, a shape, and an area of the shield members in the double-layered state are configured such that an attenuation of a magnetic field by the shield members is a value that is 50% or less of a magnetic field generated by the transmitting coil 12 in the inspection region in the absence of the shield members.

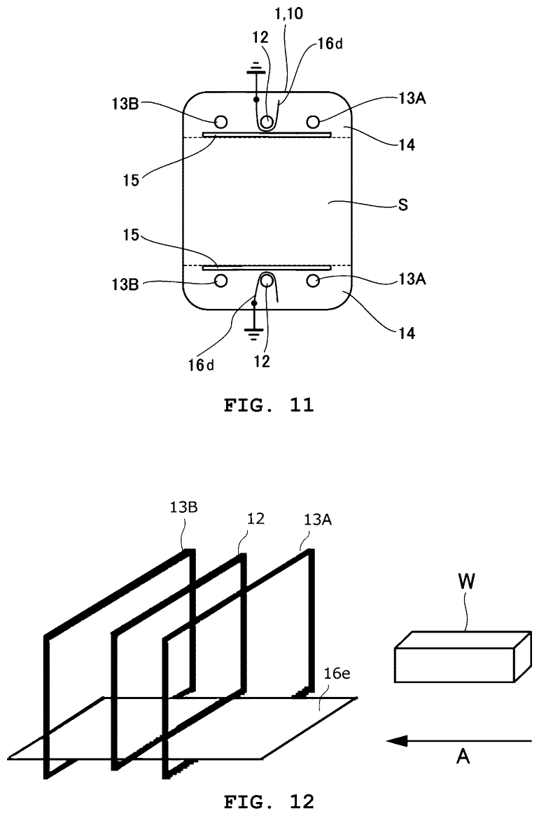

In the first and second embodiments, the shield member 16 surrounds the transmitting coil 12 or the receiving coils 13A and 13B using a combination of sheet-like members. However, the disposition of the shield member is not limited to this example. For example, as illustrated in FIG. 11, the transmitting coil 12 may be surrounded with a cylindrical shield member, or a sheet-like or linear member may be wound around the transmitting coil 12. Of course, the cylindrical shield member may surround each of the receiving coils 13A and 13B instead of the transmitting coil 12, or may surround each of the transmitting coil 12 and the receiving coils 13A and 13B. In addition, a sheet-like or linear member may be wound around each of the receiving coils 13A and 13B, or may be wound around each of the transmitting coil 12 and the receiving coils 13A and 13B.

In the third embodiment, as illustrated in FIG. 5, the shield member 16 is a sheet member extending along each of the sides of the transmitting coil 12 (or the receiving coils 13A and 13B), and is provided separately from the conductive sheet 15. However, for example, a shield member where the shield member 16 and the conductive sheet 15 are integrated may also be used in each of the sides. With this configuration, by disposing the shield member between the transmitting and receiving coils (the transmitting coil 12 and the receiving coils 13A and 13B), a part of the shield member also functions as a shield between the inspection space and the coils while surrounding the transmitting coil 12 with the shield member. That is, the shield member is inserted between the transmitting coil 12 and the receiving coils 13A and 13B, and concurrently a part of the shield member is disposed between the transmitting and receiving coils and the inspection space. In general, in a metal detector, an electrostatic shield for reducing the effect of an inspection object is inserted into the coils and an inspection space. However, with the above-described configuration, the shield member does not need to be separately provided between the transmitting and receiving coils, which is advantageous in improving manufacturability and controlling costs.

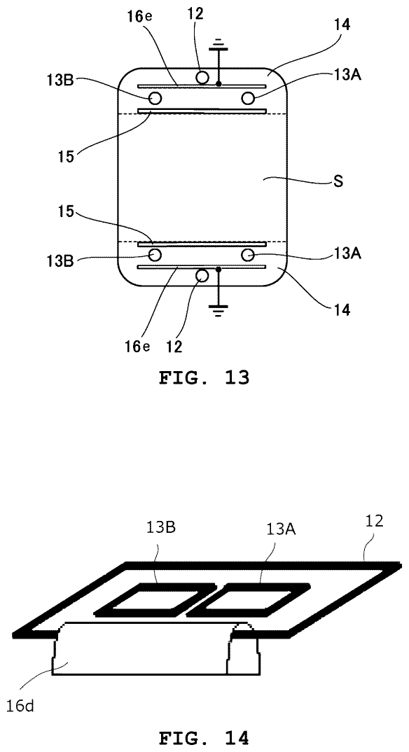

As illustrated in FIG. 12, the transmitting coil 12 and the receiving coils 13A and 13B do not overlap each other in the passage direction A of the inspection object W, and by slightly changing a position or a size such that a gap is formed between the transmitting coil 12 and the receiving coils 13A and 13B, a shield member 16e may be disposed in this gap. In FIG. 12, when seen from the passage direction A, an outer shape of the transmitting coil 12 is smaller than an outer shape of the each of the receiving coils 13A and 13B, and the shield member 16e is disposed outside the transmitting coil 12 and inside the receiving coils 13A and 13B. FIG. 12 illustrates a state where the shield member 16e is disposed on one side of the transmitting coil 12 and the receiving coils 13A and 13B. However, the shield member 16e is also disposed in the gap for each of the other three sides. In addition, in FIG. 13, an outer shape of the transmitting coil 12 may be set to be larger than an outer shape of the each of the receiving coils 13A and 13B, and the shield member 16e may be disposed in a gap formed inside the transmitting coil 12 and outside the receiving coils 13A and 13B. With this configuration, the shield member does not protrude in a direction orthogonal to the passage direction A. Therefore, the disposition of the shield member is easy.

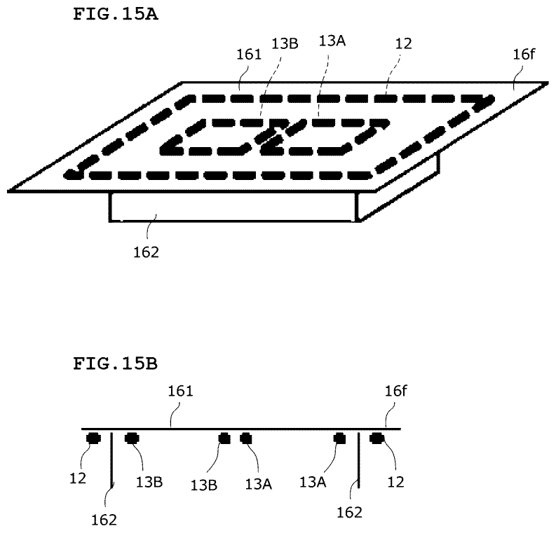

The fourth embodiment shows the example where the sheet-like shield member 16 is disposed between the transmitting coil 12 and the receiving coils 13A and 13B in the one-sided detection head 10. However, the shape and disposition of the shield member are not limited to this example. Even in the one-sided detection head, the material, disposition, shape, and area of the shield member can be changed as in the case of the coaxial type. FIGS. 14 and 15A and 15B illustrate a disposition example of shield members 16d and 16e relative to the transmitting coil 12 and the receiving coils 13A and 13B in the detection head. As illustrated in FIG. 14, the transmitting coil 12 may be surrounded with the cylindrical shield member 16d. In FIG. 14, the shield member 16d is disposed only on one side of the transmitting coil 12. Actually, however, the cylindrical shield member 16d is also disposed on the other three sides. In addition, as illustrated in FIGS. 15A and 15B, a shield member 16f where a conductive sheet 161 and a shield member 162 are integrated may also be used. The conductive sheet 161 is disposed between the transmitting coil 12 and the receiving coils 13A and 13B and the inspection object, and the shield member 162 is disposed to surround the receiving coils 13A and 13B on an inner peripheral side of the transmitting coil 12. With the shield member 16f, the shield member 162 is inserted between the transmitting coil 12 and the receiving coils 13A and 13B, and concurrently the conductive sheet 161 is disposed between the transmitting and receiving coils and the inspection space. Accordingly, the shield member does not need to be separately provided between the transmitting and receiving coils, which is advantageous in improving manufacturability and controlling costs.

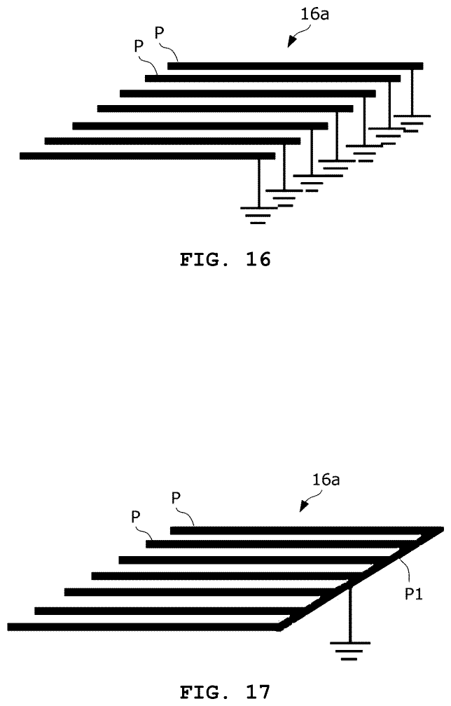

In addition, a grounding method of the shield member is not limited to the example of each of the above-described embodiments. As illustrated in FIG. 16, each of the plurality of strap portions P forming the palisaded shield member 16a may be grounded. In addition, as illustrated in FIG. 17, a connection strap portion P1 where the plurality of strap portions P are electrically connected may be provided, and the connection strap portion P1 or the strap portions P may be grounded. The connection strap portion P1 may be provided such that the plurality of strap portions P are electrically connected, and the number, position, shape, and the like of the connection strap portions P1 are not limited to the example illustrated in the drawing.

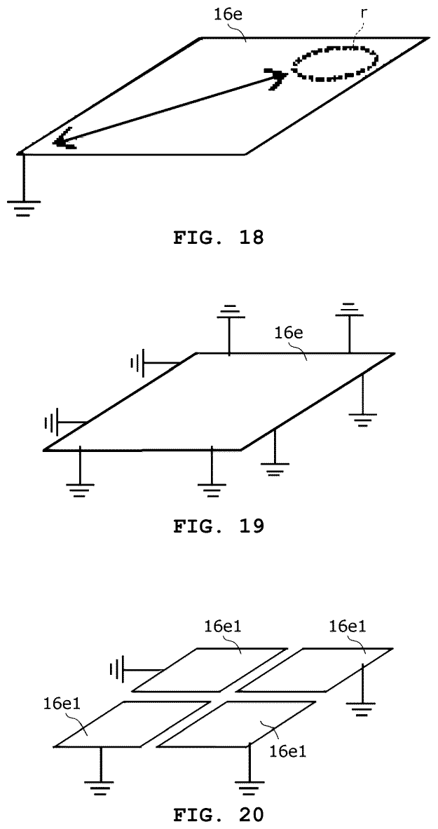

The shielding effect decreases as a distance from a grounding point increases. Therefore, as illustrated in FIG. 18, when a grounding path is provided on a single side of the sheet-like shield member 16e, the shielding effect may be insufficient at a position r far from the grounding point. In this case, by performing grounding at multiple points as illustrated in FIG. 19, a decrease in shielding effect can be prevented. In addition, by dividing the shield member 16e into a plurality of shield members 16e1 as illustrated in FIG. 20 and grounding each of the shield members 16e1, a high eddy current can be prevented from being formed in the shield member 16e.

Although various embodiments have been described above with reference to the drawings, it goes without saying that the present disclosure is not limited to such examples. It will be apparent to those skilled in the art that various modifications or alterations may be made within the scope of the claims, and it will be understood that these modifications or alterations also naturally fall within the technical scope of the present disclosure. In addition, the components in the above-described embodiments may be combined in any manner without departing from the spirit of the present disclosure.

Here, the characteristics of the metal detector according to the above-described embodiment of the present invention will be summarized and listed below.

A metal detector according to a first aspect of the present invention is a metal detector (1) that determines whether or not metal is contained in an inspection object, the metal detector (1) including: a housing (11); a transmitting coil (12) and a receiving coil (13A, 13B) disposed inside the housing; a holding material (14) configured to hold the transmitting coil and the receiving coil in the housing; and a shield member (16) disposed between the transmitting coil and the receiving coil in the housing, in which an electrical resistivity of the shield member is higher than an electrical resistivity of the housing.

In the metal detector according to the first aspect of the present invention, by disposing the shield member between the transmitting coil and the receiving coil, the degree of capacitive coupling between the transmitting coil and the receiving coil can be reduced. Therefore, a variation in balanced voltage caused by a change in the degree of capacitive coupling between the transmitting coil and the receiving coil can be reduced. Accordingly, the balance adjustment work can be facilitated, and the metal detector can be made to be easy to handle.

A metal detector according to a second aspect of the present invention is a metal detector (1) that determines whether or not metal is contained in an inspection object, the metal detector (1) including: a housing (11); a transmitting coil (12) and a receiving coil (13A, 13B) disposed inside the housing; a holding material (14) configured to hold the transmitting coil and the receiving coil in the housing; and a shield member (16) disposed between the transmitting coil and the receiving coil in the housing, in which an electrical resistivity, a disposition, a shape, and an area of the shield member are configured such that an attenuation of a magnetic field in the presence of the shield member is a value that is 50% or less of a magnetic field generated by the transmitting coil in an inspection region (S) in the absence of the shield member.

In the metal detector according to the second aspect of the present invention, by disposing the shield member having the predetermined configuration between the transmitting coil and the receiving coil, the degree of capacitive coupling between the transmitting coil and the receiving coil can be reduced. Therefore, a variation in balanced voltage caused by a change in the degree of capacitive coupling between the transmitting coil and the receiving coil can be reduced. Accordingly, the balance adjustment work can be facilitated, and the metal detector can be made to be easy to handle.

According to a third aspect of the present invention, in the metal detector according to the first aspect, a coaxial detection head where the transmitting coil and the receiving coil are disposed to form the same axis along a passage direction of the inspection object that is transported is configured. In addition, according to a fourth aspect of the present invention, in the metal detector according to the second aspect, a coaxial detection head where the transmitting coil and the receiving coil are disposed to form the same axis along a passage direction of the inspection object that is transported is configured.

In the metal detectors according to the third and fourth aspects of the present invention, since the detection head is a general coaxial type, the detection head can be easily assembled.

According to a fifth aspect of the present invention, in the metal detector according to the third aspect, the shield member covers an entirety of the receiving coil. In addition, according to a sixth aspect of the present invention, in the metal detector according to the fourth aspect, the shield member covers an entirety of the receiving coil.

In the metal detectors according to the fifth and sixth aspects of the present invention, capacitive coupling between the transmitting coil and the receiving coil can be easily and efficiently reduced.

According to a seventh aspect of the present invention, in the metal detector according to the third aspect, the shield member covers an entirety of the transmitting coil. In addition, according to an eighth aspect of the present invention, in the metal detector according to the fourth aspect, the shield member covers an entirety of the transmitting coil.

In the metal detectors according to the seventh and eighth aspects of the present invention, capacitive coupling between the transmitting coil and the receiving coil can be easily and efficiently reduced.

According to a ninth aspect of the present invention, in the metal detector according to the third aspect, the shield member is disposed between the transmitting coil and the receiving coil in a direction of the same axis. According to a tenth aspect of the present invention, in the metal detector according to the fourth aspect, the shield member is disposed between the transmitting coil and the receiving coil in a direction of the same axis.

In the metal detectors according to the ninth and tenth aspects of the present invention, capacitive coupling between the transmitting coil and the receiving coil can be easily and efficiently reduced.

According to an eleventh aspect of the present invention, in the metal detector according to the first aspect, a one-sided detection head where the transmitting coil and the receiving coil are disposed to form an axial direction of the transmitting coil and the receiving coil in a direction intersecting a passage direction of the inspection object that is transported is configured, and the shield member is disposed to intersect the axial direction of the transmitting coil and the receiving coil. In addition, according to a twelfth aspect of the present invention, in the metal detector according to the second aspect, a one-sided detection head where the transmitting coil and the receiving coil are disposed to form an axial direction of the transmitting coil and the receiving coil in a direction intersecting a passage direction of the inspection object that is transported is configured, and the shield member is disposed to intersect the axial direction of the transmitting coil and the receiving coil.

In the metal detectors according to the eleventh and twelfth aspects of the present invention, the detection head is generally a one-sided type. Therefore, the detection head can be easily assembled, and capacitive coupling between the transmitting coil and the receiving coil can be easily and efficiently reduced.

According to a thirteenth aspect of the present invention, in the metal detector according to the first aspect, the electrical resistivity of the shield member is in a range of 10⁻² Ω/□ to 10³ Ω/□. In addition, according to a fourteenth aspect of the present invention, in the metal detector according to the fifth aspect, the electrical resistivity of the shield member is in a range of 10⁻² Ω/□ to 10³ Ω/□. In addition, according to a fifteenth aspect of the present invention, in the metal detector according to the seventh aspect, the electrical resistivity of the shield member is in a range of 10⁻² Ω/□ to 10³ Ω/□.

In the metal detectors according to the thirteenth, fourteenth, and fifteenth aspects of the present invention, while reducing an excessive attenuation of a magnetic field generated from the transmitting coil in the inspection space by the shield member, capacitive coupling between the transmitting coil and the receiving coil can be reduced.

### DESCRIPTION OF REFERENCE NUMERALS AND SIGNS

1: metal detector
10: detection head
11: housing
12: transmitting coil
13A: receiving coil
13B: receiving coil
14: holding material
15: conductive sheet
16, 16a, 16b, 16c, 16d, 16e, 16f: shield member
S: inspection space

What is claimed is:

1. A metal detector that determines whether or not metal is contained in an inspection object, the metal detector comprising:
a housing;
a transmitting coil and a receiving coil disposed inside the housing;
a holding material configured to hold the transmitting coil and the receiving coil in the housing; and
a shield member disposed between the transmitting coil and the receiving coil in the housing,
wherein an electrical resistivity of the shield member is higher than an electrical resistivity of the housing.

2. A metal detector that determines whether or not metal is contained in an inspection object, the metal detector comprising:
a housing;
a transmitting coil and a receiving coil disposed inside the housing;
a holding material configured to hold the transmitting coil and the receiving coil in the housing; and
a shield member disposed between the transmitting coil and the receiving coil in the housing,
wherein an electrical resistivity, a disposition, a shape, and an area of the shield member are configured such that an attenuation of a magnetic field in the presence of the shield member is a value that is 50% or less of a magnetic field generated by the transmitting coil in an inspection region in the absence of the shield member.

3. The metal detector according to claim 1,
wherein a coaxial detection head where the transmitting coil and the receiving coil are disposed to form the same axis along a passage direction of the inspection object that is transported is configured.

4. The metal detector according to claim 2,
wherein a coaxial detection head where the transmitting coil and the receiving coil are disposed to form the same axis along a passage direction of the inspection object that is transported is configured.

5. The metal detector according to claim 3,
wherein the shield member covers an entirety of the receiving coil.

6. The metal detector according to claim 4,
wherein the shield member covers an entirety of the receiving coil.

7. The metal detector according to claim 3,
wherein the shield member covers an entirety of the transmitting coil.

8. The metal detector according to claim 4,
wherein the shield member covers an entirety of the transmitting coil.

9. The metal detector according to claim 3,
wherein the shield member is disposed between the transmitting coil and the receiving coil in a direction of the same axis.

10. The metal detector according to claim 4,
wherein the shield member is disposed between the transmitting coil and the receiving coil in a direction of the same axis.

11. The metal detector according to claim 1,
wherein a one-sided detection head where the transmitting coil and the receiving coil are disposed to form an axial direction of the transmitting coil and the receiving coil in a direction intersecting a passage direction of the inspection object that is transported is configured, and
the shield member is disposed to intersect the axial direction of the transmitting coil and the receiving coil.

12. The metal detector according to claim 2,
wherein a one-sided detection head where the transmitting coil and the receiving coil are disposed to form an axial direction of the transmitting coil and the receiving coil in a direction intersecting a passage direction of the inspection object that is transported is configured, and
the shield member is disposed to intersect the axial direction of the transmitting coil and the receiving coil.

13. The metal detector according to claim 1,
wherein the electrical resistivity of the shield member is in a range of 10⁻² Ω/□ to 10³ Ω/□.

14. The metal detector according to claim 5,
wherein the electrical resistivity of the shield member is in a range of 10⁻² Ω/□ to 10³ Ω/□.

15. The metal detector according to claim 7,
wherein the electrical resistivity of the shield member is in a range of 10⁻² Ω/□ to 10³ Ω/□.
